(19) United States
(12) Patent Application Publication
(10) Pub. No.: US 2010/0103390 A1
(43) Pub. Date: Apr. 29, 2010

(54) LITHOGRAPHIC APPARATUS AND DEVICE MANUFACTURING METHOD

(75) Inventors: Raymond Wilhelmus Louis LAFARRE, Helmond (NL); Johannes Petrus Martinus Bernardus Vermeulen, Helmond (NL); Patrick Zuidema, Mierlo (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 12/579,065

(22) Filed: Oct. 14, 2009

Related U.S. Application Data
(60) Provisional application No. 61/107,911, filed on Oct. 23, 2008.

(51) Int. Cl. G03B 27/52

(52) U.S. Cl. 355/30

(57) ABSTRACT

A lithographic projection apparatus arranged to project a pattern from a patterning device onto a substrate. The apparatus is provided with a clamp, including a support part configured to support the patterning device or the substrate and a temperature control part configured to control the temperature of the patterning device or the substrate. The clamp is constructed to mechanically isolate the temperature control part from the support part with a flexible connector so that vibrations, shrink and expansion of the temperature control part will not influence the patterning device and/or the substrate.

### CROSS REFERENCE TO RELATED APPLICATIONS

This application claims priority and benefit under 35 U.S.C. §119(e) to U.S. Provisional Patent Application No. 61/107,911, entitled “Lithographic Apparatus and Device Manufacturing Method”, filed on Oct. 23, 2008. The content of that application is incorporated herein in its entirety by reference.

### FIELD

The present invention relates to a lithographic projection apparatus arranged to project a pattern from a patterning device onto a substrate and a device manufacturing method.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In a lithographic apparatus, the patterning device and the substrate may be irradiated by a beam of radiation which may cause the temperature of the patterning device and or the substrate to increase. The patterning device and/or the substrate may expand due to the increase of temperature and imaging of a pattern on the substrate may thereby be deteriorated. The increase of temperature can be limited by providing the clamp with a temperature control part; however the temperature control part may cause vibrations and or tensions in the clamp.

### SUMMARY

It is desirable to provide a lithographic apparatus with an improved clamp.

According to an embodiment of the invention, there is provided a lithographic projection apparatus arranged to project a pattern from a patterning device onto a substrate, the apparatus being provided with a clamp, comprising a supporting part for supporting of the patterning device and/or the substrate and a temperature control part for controlling the temperature of the patterning device and/or the substrate, wherein the clamp is constructed to mechanically isolate the temperature control part from the supporting part.

In another embodiment of the invention, there is provided a lithographic apparatus including an illumination system configured to condition a radiation beam; a carrier constructed to support a patterning device, the patterning device being capable of imparting the radiation beam with a pattern in its cross-section to form a patterned radiation beam; a substrate table constructed to hold a substrate; and a projection system configured to project the patterned radiation beam onto a target portion of the substrate, the carrier and/or the substrate table being provided with a clamp for clamping the patterning device and/or the substrate respectively, wherein the clamp includes a temperature control part for controlling the temperature of the patterning device and/or the substrate, and a supporting part for supporting of the patterning device and/or the substrate, wherein the clamp is constructed to mechanically isolate the temperature control part from the supporting part.

In another embodiment of the invention, there is provided a device manufacturing method including: providing a substrate that is at least partially covered by a layer of radiation-sensitive material; providing a patterning device; projecting a patterned beam of radiation onto the layer of radiation sensitive material with a projection system; clamping the patterning device and/or the substrate with a clamp; supporting the patterning device and/or the substrate with a support part of the clamp; controlling the temperature of the patterning device and/or the substrate with a temperature control part of the clamp; and mechanically isolating the support part from the temperature control part of the clamp.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a portion of the supporting part of the clamp;

FIG. 3 depicts a cross-section of a portion of the temperature control part of the clamp;

FIG. 4 depicts a cross section of a portion of the temperature control part of the clamp provided with a flexible connector;

FIG. 5 depicts a cross-section of the clamp;

FIG. 6 depicts a cross-section of the clamp with a patterning device and/or substrate clamped on it; and

FIG. 7 depicts a cross-section of the clamp with a patterning device and or substrate clamped on it.

### DETAILED DESCRIPTION

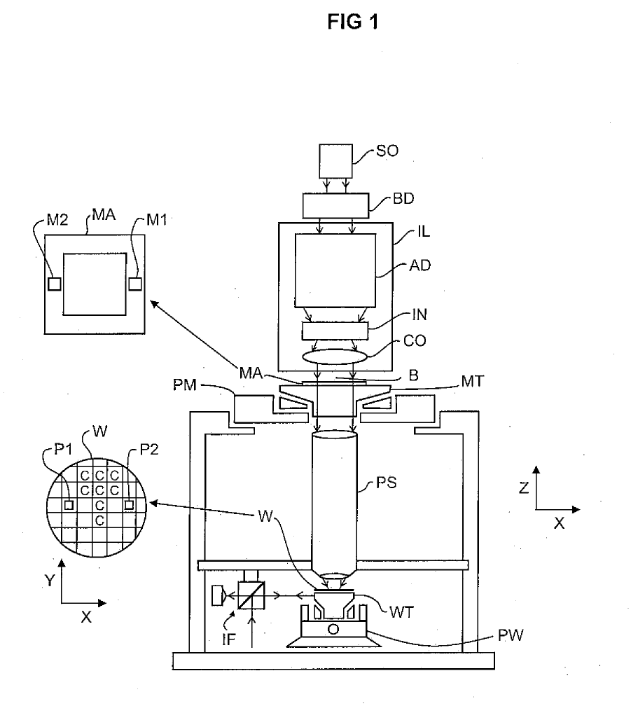

FIG. 1 schematically depicts a lithographic apparatus according to one embodiment of the invention. The apparatus includes an illumination system (illuminator) IL configured to condition a radiation beam B (e.g. UV radiation or any other suitable radiation), a patterning device support or carrier structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate carrier” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support or carrier structure holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate carriers” (and/or two or more mask tables or “mask carriers”). In such “multiple stage” machines the additional tables or carriers may be used in parallel, or preparatory steps may be carried out on one or more tables or carriers while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the patterning device and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example; suitable directing mirrors and/or abeam expander. In other cases, the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the patterning device support (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with'the aid of a long-stroke module (coarse positioning) and a short-stroke module (fine positioning), which form part of the first positioning device PM. Similarly, movement of the substrate table WT or “substrate carrier” may be realized using a long-stroke module and a short-stroke module, which form part of the second positioner PW. In the case of a stepper (as opposed to a scanner) the patterning device support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the patterning device alignment marks may be located between the dies.

The depicted apparatus could be used in at least one of the following modes:

1. In step mode, the patterning device support (e.g. mask table) MT or “patterning device carrier” and the substrate table WT or “substrate carrier” are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the patterning device support (e.g. mask table) MT or “patterning device carrier” and the substrate table WT or “substrate carrier” are scanned synchronously while a pattern imparted to the radiation beam is projected onto a target portion C (i.e. a single dynamic exposure). The velocity and direction of the substrate table WT relative to the patterning device support (e.g. mask table) MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support (e.g. mask table) MT or “patterning device carrier” is kept essentially stationary holding a programmable patterning device, and the substrate table WT or “substrate carrier” is moved or scanned while a pattern imparted to the radiation beam is projected onto a target portion C. In this mode, generally a pulsed radiation source is employed and the programmable patterning device is updated as required after, each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

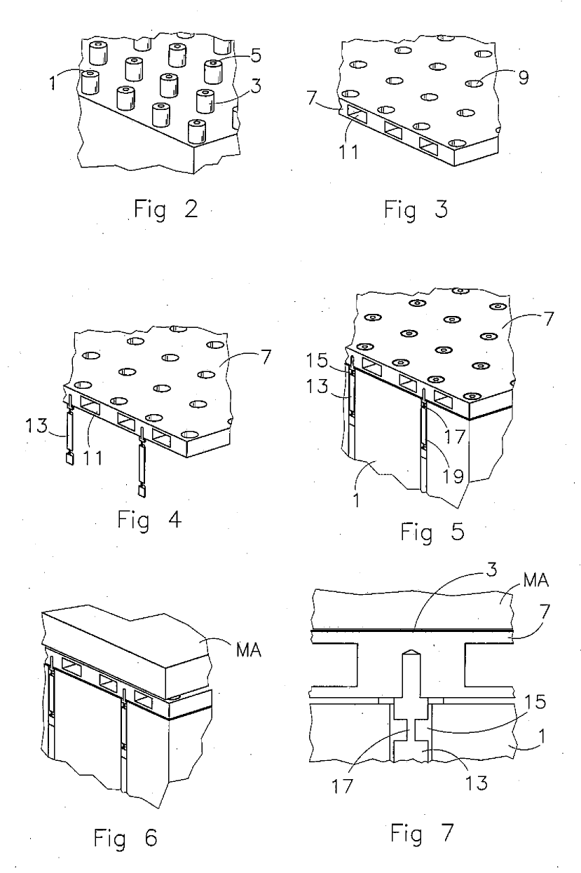

FIG. 2 depicts the supporting part 1 of the clamp. The supporting part 1 is provided with burls 3 having a contact surface 5 defining a contact site on which the patterning device MA (see FIG. 1) and/or the substrate W may be clamped during use of the clamp with, for example electrostatic or vacuum attraction. The supporting part may be provided with an electrode to electrostatically clamp the patterning device and/or the substrate in a vacuum chamber of a lithographic apparatus. The supporting part is preferably made of a material with a high stiffness, good thermal conductivity and a low thermal expansion. These material properties provide a good mechanical and thermal stability for the supporting part. Material such as, for example Zerodur™ (low expansion) or SiSiC (high stiffness and good thermal conductivity) have one or more of these properties.

FIG. 3 depicts the temperature control part 7 of the clamp. The temperature control part is provided with holes 9 to accommodate the burls 3 of the supporting part 1. The temperature control part 7 may also have an inner space 11 for accommodating a liquid to control the temperature of the clamp. The inner space 11 may be a water duct for providing cooling water in the temperature control part 7. The temperature control part may be provided with an electrode of an electrostatic clamp for electrostatically attracting the patterning device and/or the substrate to the clamp.

FIG. 4 depicts the temperature control part 7 of the clamp provided with a flexible connector 13. The flexible connector 13 mechanically isolates the temperature control part 7 from the supporting part 1 so that expansion and or crimp of the temperature control part 7 may not lead to tension in the supporting part 1 of the clamp. Also, pressure variation in the liquid which may be pumped through the inner space of the temperature control part may not influence the supporting part because the temperature control part is mechanically isolated from the supporting part. FIG. 5 depicts the complete clamp including a space 15 in the supporting part 1 to mount the flexible connector 13. The connector provides for flexibility between the temperature control part 7 and the supporting part 1 in a direction parallel to the supporting site, where the patterning device and/or the substrate is supported on the supporting part. In a direction perpendicular to the supporting site the connector provides stiffness. The connector 13 may be a spring rod including thin portions 17 and thick portions 19, wherein the thin portions provide for flexibility. The space 15 in the supporting part 1 provides also for protection against over-stressing of the flexible connector 13. If the flexible connector is stressed too much movement will be limited by the border of the space 15 in the supporting part 1.

FIG. 6 depicts the clamp with a patterning device (e.g. reticle) MA and or substrate clamped on it and FIG. 7 depicts a detailed view on the clamp with the patterning device MA and/or substrate clamped on it. During use, the patterning device and/or the substrate is in contact with the burls 3 of the supporting part 1 but not in contact with the temperature control part 7 so that the patterning device and/or the substrate is mechanically isolated from the temperature control part 7 by the flexible connector 13. The thin portion 17 of the flexible connector 13 allows the connector to move in the space 15 of the supporting part to mechanically isolate the temperature control part 7 from the supporting part 1 and the patterning device MA and/or substrate. Vibration and or expansion of the temperature control part will not influence the supporting part so that the patterning device and/or the substrate will be held in a fixed position.

In an embodiment there is provided a lithographic apparatus arranged to project a pattern from a patterning device onto a substrate. The apparatus includes a clamp which includes a supporting part configured to support one of the patterning device or the substrate. The clamp is further configured to support a temperature control part configured to control the temperature of the one of the patterning device or the substrate. The clamp is constructed to mechanically isolate the temperature control part from the supporting part.

The clamp may be constructed to mechanically isolate the temperature control part from the supporting part so as to isolate the supporting part of vibrations, or expansion, or both vibrations and expansion, of the temperature control part.

The supporting part may include burls provided with a contact surface which define a supporting site where the one of the patterning device or the substrate during use is supported. The temperature control part may be provided with holes to accommodate the burls of the supporting part.

The supporting part and the temperature control part may be connected to each other with a flexible connector so as to provide mechanical isolation between the supporting part and the temperature control part. The flexible connector may provide flexibility for the temperature control part with respect to the supporting part substantially parallel to a supporting site configured to support the substrate or the patterning device. The flexible connector may be configured to provide stiffness in a direction substantially perpendicular to the supporting site. The flexible connector may be a spring rod.

The temperature control part may be provided with an inner space for accommodating a liquid.

The clamp may include an electrostatic clamp configured to clamp the one of the patterning device or the substrate within a vacuum chamber of the lithographic apparatus. The electrostatic clamp may include an electrode configured to clamp the one of the patterning device or the substrate.

The clamp may be provided to a carrier constructed to support a patterning device which is capable of imparting the radiation beam with a pattern in its cross-section to form a patterned radiation beam. The clamp may be provided to a substrate table constructed to hold a substrate.

In an embodiment the lithographic apparatus further includes an additional clamp including a supporting part. The supporting part is configured to support the other one of the patterning device or the substrate and a temperature control part. The temperature control part is configured to control the temperature of the other one of the patterning device or the substrate. The additional clamp is constructed to mechanically isolate the temperature control part of the additional clamp from the supporting part of the additional clamp.

In an embodiment there is provided a lithographic apparatus including an illumination system configured to condition a radiation beam and a carrier constructed to support a patterning device. The patterning device is capable of imparting the radiation beam with a pattern in its cross-section to form a patterned radiation beam. The lithographic apparatus further includes a substrate table constructed to hold a substrate and a projection system configured to project the patterned radiation beam onto a target portion of the substrate. At least one of the carrier or the substrate table is provided with a clamp configured to clamp the one of the patterning device or the substrate. The clamp includes a temperature control part and a supporting part. The temperature control part is configured to control the temperature of the one of the patterning device or the substrate. The supporting part is configured to support the one of the patterning device or the substrate. The clamp is constructed to mechanically isolate the temperature control part from the supporting part.

The lithographic apparatus may further comprise an additional clamp including a supporting part configured to support the other one of the patterning device or the substrate. The additional clamp further may include a temperature control part configured to control the temperature of the other one of the patterning device or the substrate. The additional clamp may be constructed to mechanically isolate the temperature control part of the additional clamp from the supporting part of the additional clamp.

In an embodiment there is provided a device manufacturing method including providing a substrate that is at least partially covered by a layer of radiation-sensitive material and providing a patterning device. The method further includes projecting a patterned beam of radiation onto the layer of radiation sensitive material with a projection system and clamping at least one of the patterning device or the substrate with a clamp. The method further includes supporting the at least one of the patterning device or the substrate with a supporting part of the clamp and controlling the temperature of the at least one of the patterning device or the substrate with a temperature control part of the clamp. The method further includes mechanically isolating the supporting part from the temperature control part of the clamp.

The device manufacturing method may further include clamping the other one of the patterning device or the substrate with an additional clamp and supporting the other one of the patterning device or the substrate with a supporting part of the additional clamp. The method may farther include controlling the temperature of the other one of the patterning device or the substrate with a temperature control part of the additional clamp, and mechanically isolating the supporting part of the additional clamp from the temperature control part of the additional clamp.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

What is claimed is:

1. A lithographic apparatus arranged to project a pattern from a patterning device onto a substrate, the apparatus comprising a clamp, the clamp comprising a supporting part configured to support one of the patterning device or the substrate and a temperature control part configured to control the temperature of said one of the patterning device or the substrate, wherein the clamp is constructed to mechanically isolate the temperature control part from the supporting part.

2. The lithographic apparatus according to claim 1, wherein the clamp is constructed to mechanically isolate the temperature control part from the supporting part so as to isolate the supporting part of vibrations, or expansion, or both vibrations and expansion, of the temperature control part.

3. The lithographic apparatus according to claim 1, wherein the supporting part is in contact with said one of the patterning device or the substrate during use.

4. The lithographic apparatus according to claim 1, wherein the supporting part comprises burls provided with a contact surface which define a supporting site where said one of the patterning device or the substrate during use is supported.

5. The lithographic apparatus according to claim 4, wherein the temperature control part is provided with holes to accommodate the burls of the supporting part.

6. The lithographic apparatus according to claim 1, wherein the supporting part and the temperature control part are connected to each other with a flexible connector so as to provide mechanical isolation between the supporting part and the temperature control part.

7. The lithographic apparatus according to claim 6, wherein the flexible connector provides flexibility for the temperature control part with respect to the supporting part substantially parallel to a supporting site configured to support the substrate or the patterning device.

8. The lithographic apparatus according to claim 7, wherein the flexible connector is configured to provide stiffness in a direction substantially perpendicular to the supporting site.

9. The lithographic apparatus according to claim 8, wherein the flexible connector is a spring rod.

10. The lithographic apparatus according to claim 1, wherein the temperature control part is provided with an inner space for accommodating a liquid.

11. The lithographic apparatus according to claim 1, wherein the clamp comprises an electrostatic clamp configured to clamp said one of the patterning device or the substrate within a vacuum chamber of the lithographic apparatus.

12. The lithographic apparatus according to claim 11, wherein the electrostatic clamp comprises an electrode configured to clamp said one of the patterning device or the substrate.

13. The lithographic apparatus according to claim 1 wherein the clamp is provided to a carrier constructed to support a patterning device, the patterning device being capable of imparting the radiation beam with a pattern in its cross-section to form a patterned radiation beam.

14. The lithographic apparatus according to claim 1, wherein the clamp is provided to a substrate table constructed to hold a substrate.

15. The lithographic apparatus according to claim 1, further comprising an additional clamp, the additional clamp comprising a supporting part configured to support the other one of the patterning device or the substrate and a temperature control part configured to control the temperature of the other one of the patterning device or the substrate, wherein the additional clamp is constructed to mechanically isolate the temperature control part of the additional clamp from the supporting part of the additional clamp.

16. A lithographic apparatus comprising:
an illumination system configured to condition a radiation beam;
a carrier constructed to support a patterning device, the patterning device being capable of imparting the radiation beam with a pattern in its cross-section to form a patterned radiation beam;
a substrate table constructed to hold a substrate; and
a projection system configured to project the patterned radiation beam onto a target portion of the substrate,
wherein at least one of the carrier or the substrate table is provided with a clamp configured to clamp said one of the patterning device or the substrate, the clamp comprising a temperature control part configured to control the temperature of said one of the patterning device or the substrate, and a supporting part configured to support said one of the patterning device or the substrate, wherein the clamp is constructed to mechanically isolate the temperature control part from the supporting part.

17. The lithographic apparatus according to claim 16, further comprising an additional clamp, the additional clamp comprising a supporting part configured to support the other one of the patterning device or the substrate and a temperature control part configured to control the temperature of the other one of the patterning device or the substrate, wherein the additional clamp is constructed to mechanically isolate the temperature control part of the additional clamp from the supporting part of the additional clamp.

18. A device manufacturing method comprising:
providing a substrate that is at least partially covered by a layer of radiation-sensitive material;
providing a patterning device;
projecting a patterned beam of radiation onto the layer of radiation sensitive material with a projection system;
clamping at least one the patterning device or the substrate with a clamp;
supporting said at least one of the patterning device or the substrate with a supporting part of the clamp;
controlling the temperature of said at least one of the patterning device or the substrate with a temperature control part of the clamp; and
mechanically isolating the supporting part from the temperature control part of the clamp.

19. The method of claim 18, further comprising
clamping the other one of the patterning device or the substrate with an additional clamp;
supporting the other one of the patterning device or the substrate with a supporting part of the additional clamp;
controlling the temperature of the other one of the patterning device or the substrate with a temperature control part of the additional clamp; and
mechanically isolating the supporting part of the additional clamp from the temperature control part of the additional clamp.
